(19) United States
(12) Patent Application Publication
(10) Pub. No.: US 2011/0228472 A1
(43) Pub. Date: Sep. 22, 2011

(54) APPARATUS, SYSTEM, AND METHOD FOR ROUTING A POWER CABLE ASSEMBLY

(75) Inventors: Albert Vincent Makley, Morrisville, NC (US); Timothy Samuel Farrow, Cary, NC (US); William Fred Martin-Otto, Apex, NC (US); Marc Richard Pamley, Durham, NC (US)

(73) Assignee: LENOVO (SINGAPORE) PTE, LTD., New Tech Park (SG)

(21) Appl. No.: 12/727,772

(22) Filed: Mar. 19, 2010

(51) Int. Cl. G06F 1/16

(52) U.S. Cl. 361/679.58; 361/679.02

(57) ABSTRACT

An apparatus, system, and method are disclosed for routing a power cable assembly. A motherboard is disposed in a chassis. A power cable assembly is routed parallel to a plane of the motherboard and comprises a plurality of power cables. Each power cable is in physical and electrical communication with a power supply. The power cable assembly is organized in a 1×n array, wherein n is a positive integer greater than five and the power cable assembly is in electrical communication with the motherboard.

### BACKGROUND

1. Field

The subject matter disclosed herein relates to power cable assemblies and more particularly relates to routing a power cable assembly.

2. Description of the Related Art

Data processing devices such as a tower computer often comprise a chassis and a plurality of components disposed within the chassis. For example, the chassis may include a motherboard, storage devices, and a power supply. A bezel or cover may sheath the chassis.

It is often advantageous to reduce the size of the chassis, particularly a width of the chassis. Unfortunately, reducing the size of the data processing device, such as by reducing the width of the chassis, may increase the separation between components, making it difficult to route a power cable assembly between the components.

### SUMMARY

Based on the foregoing discussion, the inventors have recognized a need for an apparatus, system, and method that routes a power cable assembly. Beneficially, such an apparatus, system, and method would support a reduced chassis size.

The embodiments of the present invention have been developed in response to the present state of the art, and in particular, in response to the problems and needs in the art that have not yet been fully solved by currently available power cable assembly routing methods. Accordingly, the embodiments have been developed to provide an apparatus, system, and method for routing a power cable assembly that overcome many or all of the above-discussed shortcomings in the art.

The apparatus for routing a power cable assembly includes a motherboard and a power cable assembly. The motherboard is disposed in a chassis. The power cable assembly is routed parallel to a plane of the motherboard and comprises a plurality of power cables. Each power cable is in physical and electrical communication with a power supply. The power cable assembly is organized in a 1×n array, wherein n is a positive integer greater than five and the power cable assembly is in electrical communication with the motherboard.

A system is also presented for routing a power cable assembly. The system may be embodied in a tower computer. In particular, the system, in one embodiment, includes a chassis, a motherboard, a power supply, and a power cable assembly.

The motherboard is disposed in the chassis. The power supply is also disposed in the chassis. The power cable assembly is routed parallel to a plane of the motherboard and comprises a plurality of power cables. Each power cable is in physical and electrical communication with the power supply. The power cable assembly is organized in a 1×n array, wherein n is a positive integer greater than five and the power cable assembly is in electrical communication with the motherboard.

A method is presented for routing a power cable assembly. The method may perform the steps of the apparatus and system. A motherboard is disposed in a chassis. A power cable assembly is routed parallel to a plane of the motherboard. The power cable assembly comprises a plurality of power cables. Each power cable is in physical and electrical communication with a power supply. The power cable assembly is organized in a 1×n array, wherein n is a positive integer greater than five and the power cable assembly is in electrical communication.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

In order that the advantages of the embodiments will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a side view drawing illustrating one embodiment of a data processing device;

FIG. 2 is a front view drawing illustrating one embodiment of a data processing device;

FIG. 3 is a front view drawing illustrating one alternate embodiment of a data processing device;

FIG. 4 is a perspective drawing illustrating one embodiment of a data processing device with power cable assembly;

FIG. 5 is a perspective drawing illustrating one embodiment of a data processing device with cover;

FIG. 6 is a schematic flow chart diagram illustrating one embodiment of a power cable assembly routing method;

FIG. 7 is a schematic flow chart diagram illustrating one alternate embodiment of a power cable assembly routing method; and

FIG. 8 is a top view drawing illustrating one embodiment of a power cable assembly.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, specific details of power cable assembly routing are presented to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

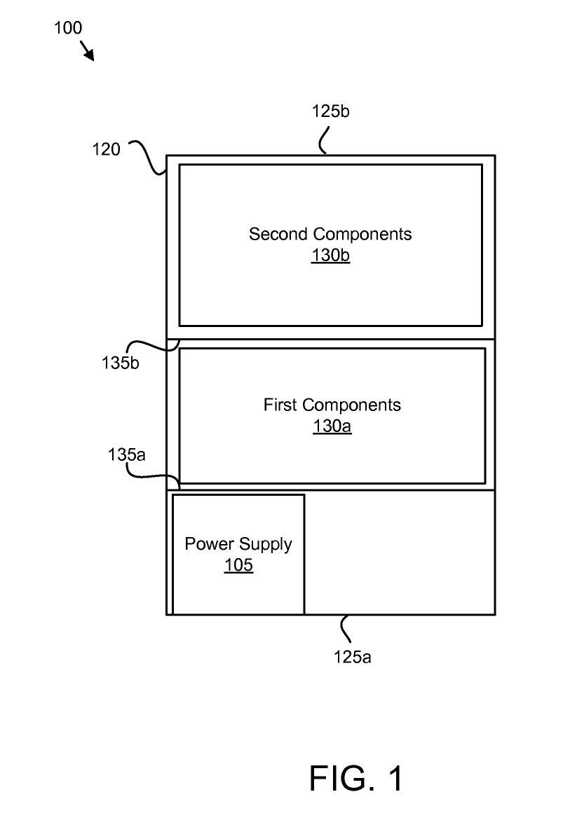

FIG. 1 is a side view drawing illustrating one embodiment of a data processing device 100. The data processing device 100 includes a chassis 120. The chassis 120 may comprise one or more rigid materials such as plastic, aluminum, and the like. The materials of the chassis 120 may be organized as a plurality of walls enclosing an interior area. Alternatively, the materials of the chassis 120 may be organized as a framework enclosing the interior area. In one embodiment, the chassis 120 includes a first end 125a and a second end 125b.

Components 130 may be disposed in the chassis 120. In a certain embodiment, the components 130 are organized as first components 130a and second components 130b. The first components 130b may include a motherboard. The motherboard may be disposed in a second end 125b of the chassis 120. In one embodiment, a power supply 105 is disposed in the first end 125a of the chassis 120.

In one embodiment, the chassis 120 includes a plurality of baffles 135. For example, a first baffle 135a may partially segregate the power supply 105 from the first components 130a. In addition, the second baffle 135b may partially segregate the first components 130a from the second components 130b.

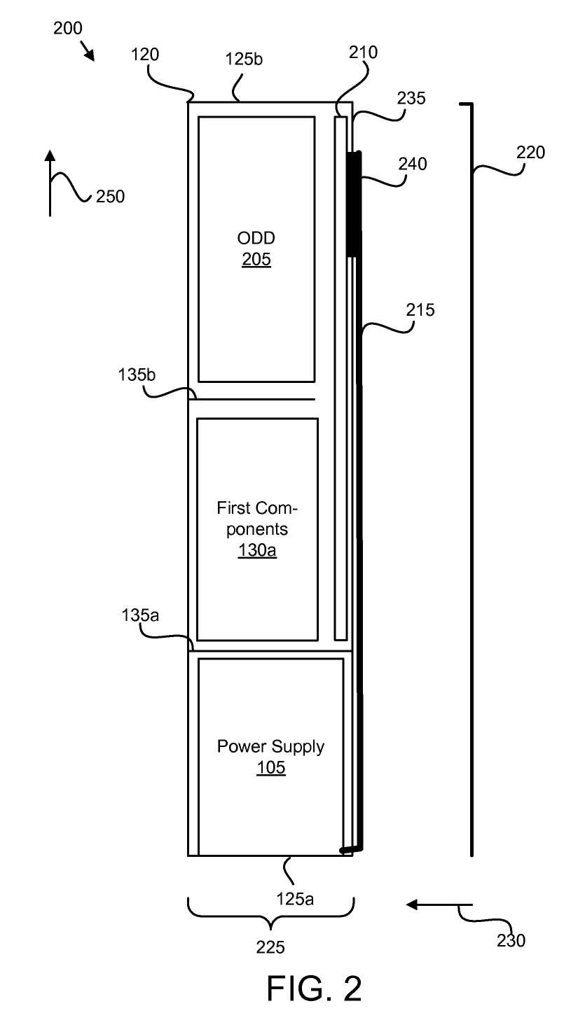

FIG. 2 is a front view drawing illustrating one embodiment of a data processing device 200. The data processing device 200 is the data processing device 100 of FIG. 1. The description of the data processing device 200 refers to elements of FIG. 1, like numbers referring to like elements. The data processing device 200 includes the chassis 120, power supply 105, baffles 135, and first components 130a of FIG. 1. In addition, an optical disk drive 205, a motherboard 210, a power cable assembly 215, a wall 235, a cover 220, and a connection 240 are shown.

In one embodiment, a chassis width 225 is in the range of 12.5 to 13.34 centimeters. As a result, devices within the chassis may be dispersed along a second axis 250 between the first end 125a and the second end 125b. In the depicted embodiment, the power supply 105 is disposed at the first end 125a and the motherboard 210 is disposed at the second end 125b. The power cable assembly 215 must be routed from the power supply 105 to the motherboard 210.

The power cable assembly 215 is in physical and electrical communication with the power supply 105. The power cable assembly 215 is also in electrical communication with the motherboard 210. In addition, the power cable assembly 215 may be in physical communication with the motherboard 210. The motherboard 210 may be an Advanced Technology Extended (ATX) compliant motherboard.

In one embodiment, the motherboard 210 extends from the second end 125b towards the first end 125a along the second axis 250 without overlapping the power supply 105 along the second axis 250. The motherboard 210 may overlap the optical disk drive 205 and first components 130a along the second axis 250.

In one embodiment, the power cable assembly 215 is organized in a 1×n array, where n is a positive integer greater than five. Thus the power cable assembly 215 may have a planar geometry as will be discussed hereafter for FIG. 8.

The power cable assembly 215 may connect to the motherboard 210 at the connection 240. In one embodiment, the connection 240 comprises a first connector in electrical and physical communication with the power cable assembly 215 and a corresponding second connector disposed on a motherboard 210 as is well known to those of skill in the art.

The power cable assembly 215 is routed parallel to a plane of the motherboard 210. In one embodiment, the plane of the motherboard 210 is orthogonal to a first axis 230 of the chassis width 225. In a certain embodiment, the plane of the power cable assembly 215 is routed parallel to the plane of the motherboard 210.

In one embodiment, the motherboard 210 is disposed adjacent and parallel to an inner face of the wall 235. The inner face is interior to the chassis 120. In a certain embodiment, the power cable assembly 215 is routed adjacent to an outer face of the wall 235. In addition, the power cable assembly 215 may be routed parallel to the outer face of the wall 235. Alternatively, the power cable assembly 215 may be routed adjacent to the inner face of the wall 235. In addition, the power cable assembly 215 may be routed parallel to the inner face of the wall 235.

In one embodiment, the cover 220 removably attaches to the chassis 120. The cover 220 may cover the wall 235. The power cable assembly 215 may be disposed between the outer face of the wall 235 and the cover 220. By disposing the power cable assembly 215 between the outer face of the wall 235 and the cover 220, the power cable assembly 215 may be protected from contact with the components 130 within the chassis 120. For example, the components 130 such as the motherboard 210 may include protruding bolts, wires, and the like. By disposing the power cable assembly 215 between the outer face of the wall 235 and the cover 220, the power cable assembly 215 is protected from scoring, abrasion, cutting, and the like from contact with the components 130.

In one embodiment the power cable assembly 215 is routed adjacent the first component 130a. The first components 130a may be disposed between the power supply 105 and the connection 240 of the power cable assembly 215 to the motherboard 210. Because the power cable assembly 215 is disposed parallel to the plane of the motherboard 210 and orthogonal to the first axis 230, the power cable assembly 215 may also pass between the first component 130a and the wall 235 with minimal clearance.

Routing the power cable assembly 215 parallel to the plane of the motherboard 210 supports the narrowing of the chassis width 225. In addition, routing the power cable assembly 215 parallel to the plane of the motherboard supports distributing devices such as the motherboard 210 and power supply 105 more widely along the second axis 250.

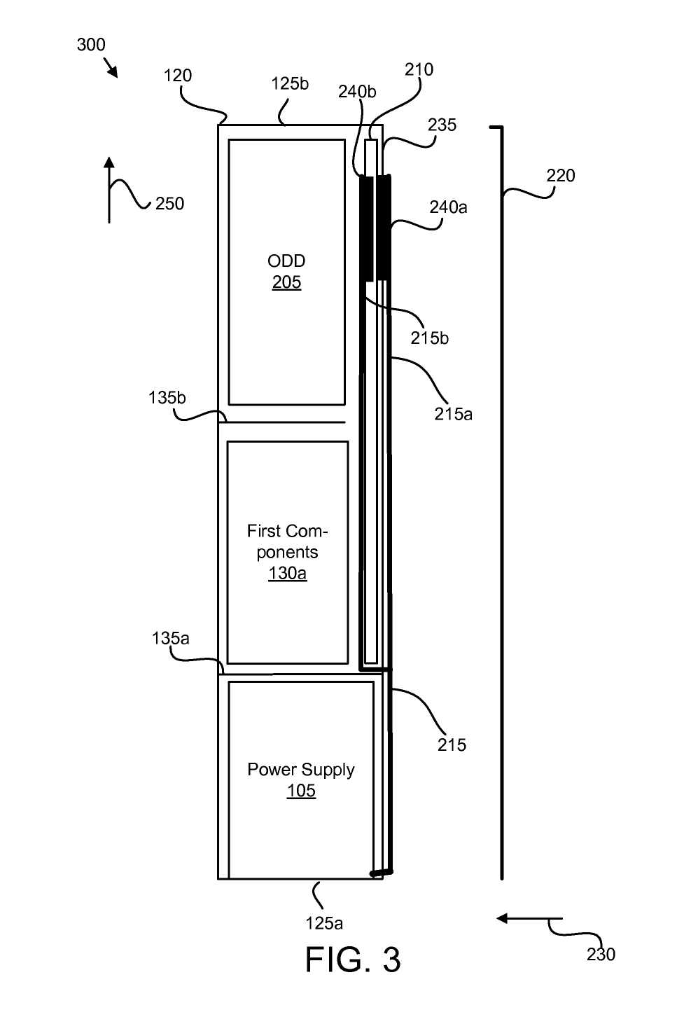

FIG. 3 is a front view drawing illustrating one alternate embodiment of a data processing device 300. The data processing device 300 may be the data processing devices 100, 200 of FIGS. 1-2. The description of the data processing device 300 refers to elements of FIGS. 1-2, like numbers referring to like elements. The data processing device 300 includes the chassis 120, power supply 105, baffles 135, first components 130a, optical disk drive 205, motherboard 210, wall 235, and cover 220.

In addition, the data processing device 300 includes a first connection 240a and a second connection 240b. The power cable assembly 215 may include a first portion 215a and a second portion 215b.

The first portion 215a of the power cable assembly 215 is routed across a first side of the motherboard 210. The first portion 215a may connect to the motherboard 210 at a first connection 240a. A plane of the first portion 215a of the power cable assembly 215 may be parallel to the plane of the motherboard 210. In addition, the first portion 215a of the power cable assembly 215 may be adjacent to the motherboard 210.

The second portion 215b of the power cable assembly 215 is routed across the second side of the motherboard 210. The second portion 215b may connect to the motherboard 210 at a second connection 240b. A plane of the second portion 215b of the power cable assembly 215 may be parallel to the plane of the motherboard 210. In addition, the second portion 215b of the power cable assembly 215 may be adjacent to the motherboard 210.

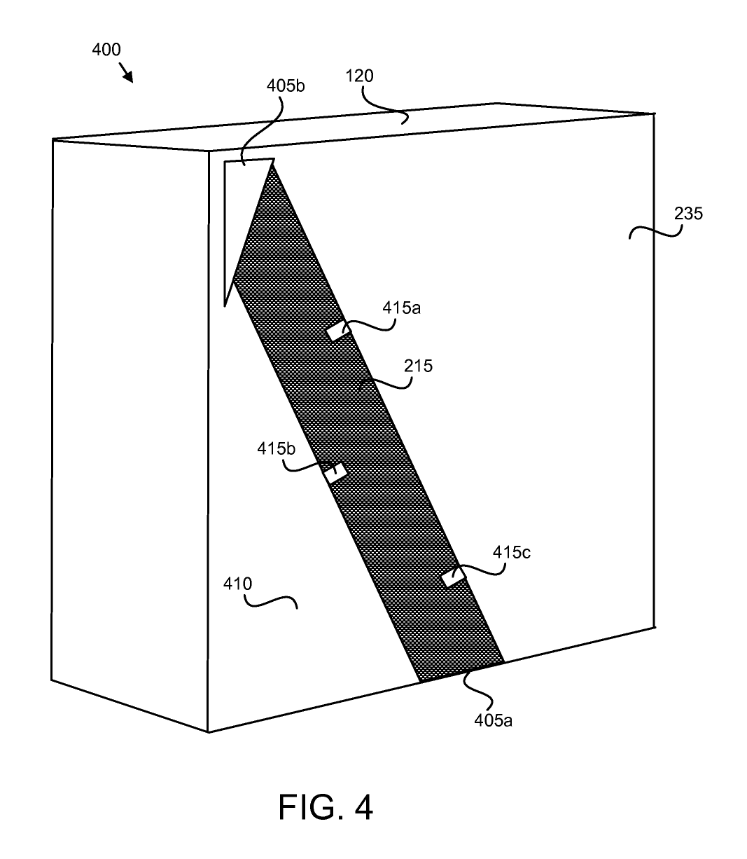

FIG. 4 is a perspective drawing illustrating one embodiment of a data processing device 400 with power cable assembly 215. The data processing device 400 may be the data processing devices 100, 200, 300 FIGS. 1-3. The description of the data processing device 400 refers to elements of FIGS. 1-3, like numbers referring to like elements.

The data processing device 400 shows the chassis 120 with cover 220 removed and the wall 235 exposed. The power cable assembly 215 is routed from the interior of the chassis 112 through a first opening 405a in the wall 235. In addition, the power cable assembly 215 may routed adjacent to the outer face 410 of the wall 235. In one embodiment, the power cable assembly 215 is routed parallel to the outer face 410 of the wall 235.

In one embodiment, at least one retention device 415 retains the power cable assembly 215 flush with the outer face 410 of the wall 235. The retention device 415 may be a tab. The tab may be formed from the wall 235. For example, if the wall 235 is formed of sheet metal, the tab may be punched from the sheet metal. Alternatively, if the wall is formed of plastic, the tab may be molded as part of the wall 235.

In an alternate embodiment, the retention device 415 may be a tie strap. The tie strap may extend across the plane of the power cable assembly 215. The tie strap may further be anchored to the wall 235. In one embodiment, the tie strap passes through a perforation in the wall 235 and may be anchored within the wall 235. In one embodiment, the tie strap forms a loop with a first portion of the loop disposed along the outer face 410 of the wall 235 and a second portion of the loop disposed along the inner face of the wall 235.

In one embodiment, the retention device 415 is double-sided tape. The double-sided tape may be disposed along and adhere to the outer face 410 of the wall 235 along a route of the power cable assembly 215 from the first opening 405a to the second opening 405b. In addition, the double-sided tape may adhere to the power cable assembly 215, retaining the power cable assembly 215 flush with the outer face 410 of the wall 235.

In one embodiment, the retention device 415 is a VELCRO® fastener. The VELCRO® fastener may comprise a first fastener and a second fastener with the first fastener disposed on the outer face 410 of the wall 235 and the second fastener disposed on the power cable assembly 215. The first and second fasteners may interconnect together to hold the power cable assembly 215 flush with the outer face 410 of the wall 235.

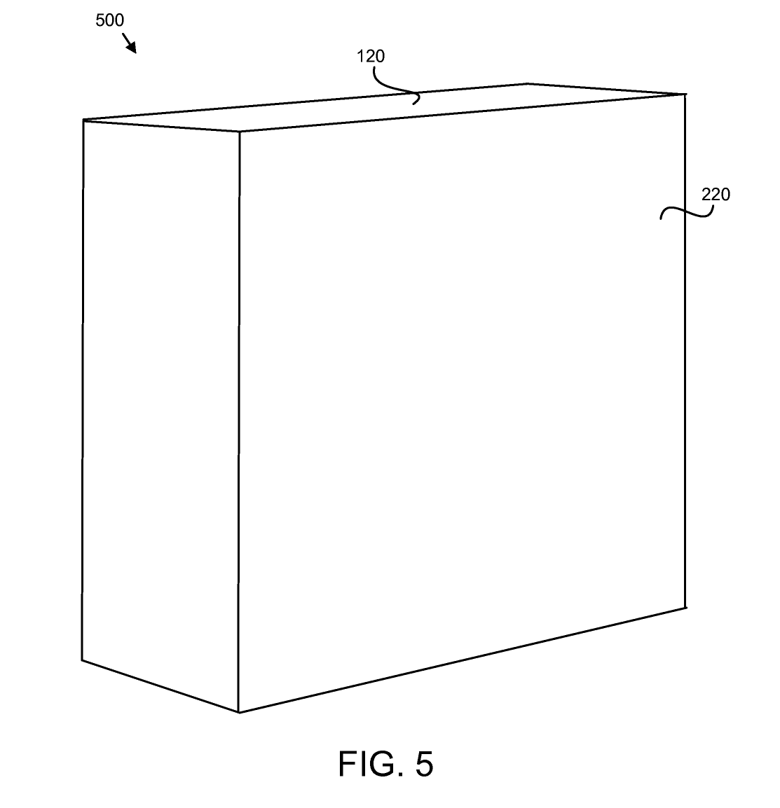

FIG. 5 is a perspective drawing illustrating one embodiment of a data processing device 500 with cover 220. The data processing device 500 is the data processing devices 100, 200, 300, 400 of FIGS. 1-4. The description of the data processing device 500 refers to elements of FIGS. 1-5, like numbers referring to like elements.

The chassis 120 is shown. The cover 220 is also shown in place covering the wall 235. The power cable assembly 215 is disposed between the cover 220 and the outer face 410 of the wall 235.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

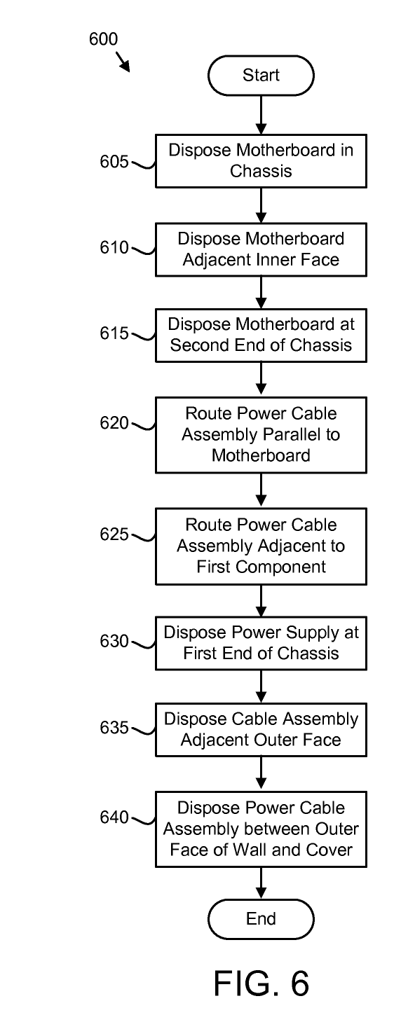

FIG. 6 is a schematic flow chart diagram illustrating one embodiment of a power cable assembly routing method 600. The method 600 in one embodiment substantially includes the steps to carry out the functions presented above with respect to the operation of the described apparatus and system of FIGS. 1-5. The description of the method 600 refers to elements of FIGS. 1-5, like numbers referring to like elements.

The method 600 starts and in one embodiment, the motherboard 210 is disposed 605 in the chassis 120. The motherboard 210 may be mounted to a bracket, a ledge, a stand, or the like. In one embodiment, the motherboard 210 is in mechanical communication with the chassis 120.

In one embodiment, the motherboard 210 is disposed 610 adjacent the interface of the wall 235. In addition, the plane of the motherboard 210 may be disposed 610 parallel to a plane of the wall 235.

The motherboard 210 may be disposed 615 at the second end 125b of the chassis 120. In one embodiment, the second end 125b is a top of the chassis 120.

In one embodiment, the power cable assembly 215 is routed 620 parallel to the motherboard 210. The plane of the power cable assembly 215 may be routed 620 parallel to the plane of the motherboard 210.

The power cable assembly 215 may be routed 625 adjacent to the first component 130a. In one embodiment, the power cable assembly 215 is routed 625 between the first component 130a and the inner face of the wall 235.

In one embodiment, the power supply 105 is disposed 630 at the first end 125a of the chassis 120. The first end 125a may be the bottom of the chassis 120.

The power cable assembly 215 may be disposed 635 adjacent the outer face 410 of the wall 235. In addition, the power supply assembly 215 may be disposed 635 parallel to the outer face 410 of the wall 235. In a certain embodiment, the plane of the power supply assembly 215 may be disposed 635 adjacent and parallel to the plane of the outer face 410 of the wall 235.

The cover 220 may be attached to the chassis 120. The cover 220 may cover the wall 235 when attached to the chassis 120. In one embodiment, the power cable assembly 215 is disposed 640 between the outer face 410 of the wall 235 and the cover 220 and the method 600 ends.

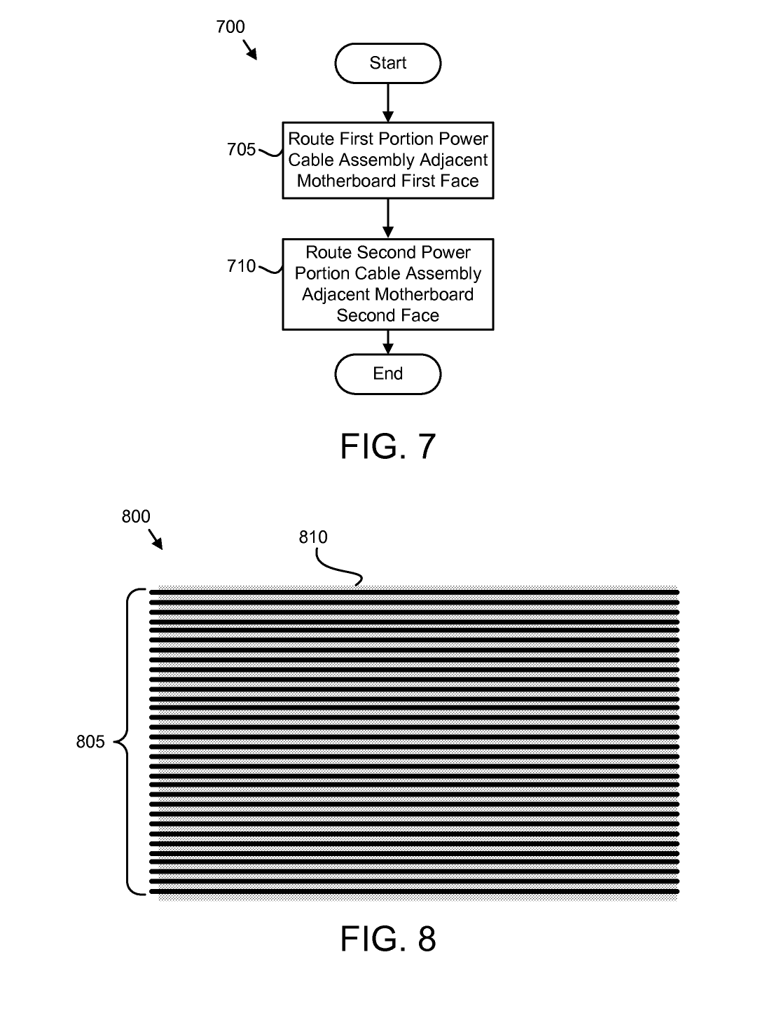

FIG. 7 is a schematic flow chart diagram illustrating one alternate embodiment of a power cable assembly routing method 700. The method 700 may perform step 615 of the method 600 of FIG. 6. The description of the method 700 refers to elements of FIGS. 1-5 in addition to step 615 FIG. 6, like numbers referring to like elements.

The method 700 starts, and in one embodiment, the first portion 215a of the power cable assembly 215 is routed 705 adjacent to a first face of the motherboard 210. In one embodiment, the first face of the motherboard 210 is closest to the wall 235.

In addition, the second portion 215b of the power cable assembly 215 may be routed 710 adjacent to a second face of the motherboard 210. In one embodiment, the second face of the motherboard 210 is an interior-most face of the motherboard 210.

FIG. 8 is a top view drawing illustrating one embodiment of a power cable assembly 215. The power cable assembly 215 is the power cable assembly 215 FIGS. 2-4. The description of the power cable assembly 215 refers to elements of FIGS. 1-7, like numbers referring to like elements.

The power cable assembly 215 includes a plurality of power cables 805. In one embodiment, each power cable 805 is of the gauge in the range of 14 to 24 gauge. The power cable assembly is organized in a 1×n array of power cables 805, where n is a positive integer greater than five. In one embodiment, n is a positive integer greater than 29. The power cable assembly 215 is depicted looking orthogonal to the plane of the power cable assembly 215, with the plane of the power cable assembly 215 parallel to the drawing sheet.

In one embodiment, the power cables 805 are bound together in the 1×n array by a flexible insulating material 810. The flexible insulating material 810 may separate the power cables 805 and insulate between the power cables 805 and other devices within the chassis 120.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a motherboard disposed in a chassis; and
a power cable assembly routed parallel to a plane of the motherboard and comprising a plurality of power cables each in physical and electrical communication with a power supply, the power cable assembly organized in a 1×n array of power cables wherein n is a positive integer greater than five and the power cable assembly is in electrical communication with the motherboard.

2. The apparatus of claim 1, wherein the power cable assembly is routed between the motherboard and an inner face of a wall of the chassis.

3. The apparatus of claim 1, the chassis comprising a wall, wherein the motherboard is disposed adjacent and parallel to an inner face of the wall and the power cable assembly is routed adjacent to an outer face of the wall.

4. The apparatus of claim 3, further comprising a retention device retaining the power cable assembly flush with the outer face of the wall, the retention device selected from the group consisting of a tab, a tie strap, double-sided tape, and a VELCRO® fastener.

5. The apparatus of claim 3, further comprising a cover removably attached to the chassis and covering the wall, wherein the power cable assembly is disposed between the outer face of the wall and the cover.

6. The apparatus of claim 5, wherein the power cable assembly is further routed adjacent a first component disposed between the power supply and a connection of the power cable assembly to the motherboard.

7. The apparatus of claim 1, wherein the power supply is disposed at a first end of the chassis and the motherboard is disposed at a second end of the chassis.

8. The apparatus of claim 7, wherein a width of the chassis is in the range of 12.5 to 13.34 centimeters.

9. The apparatus of claim 1, wherein the power cable assembly comprises a first portion and a second portion, the first portion routed across a first side of the motherboard and the second portion routed across a second side of the motherboard.

10. The apparatus of claim 1, wherein the motherboard is an Advanced Technology Extended (ATX) compliant motherboard.

11. The apparatus of claim 1, wherein each power cable is of a gauge in the range of 14 to 24 gauge.

12. A system comprising:
a chassis;
a motherboard disposed in the chassis;
a power supply disposed in the chassis; and
a power cable assembly routed parallel to a plane of the motherboard and comprising a plurality of power cables each in physical and electrical communication with the power supply, the power cable assembly organized in a 1×n array of power cables wherein n is a positive integer greater than five and the power cable assembly is in electrical communication with the motherboard.

13. The system of claim 12, wherein the power cable assembly is routed between the motherboard and an inner face of a wall of the chassis.

14. The system of claim 12, the chassis comprising a wall, wherein the motherboard is disposed adjacent and parallel to an inner face of the wall and the power cable assembly is routed adjacent to an outer face of the wall.

15. The system of claim 14, further comprising a cover removably attached to the chassis and covering the wall, wherein the power cable assembly is disposed between the outer face of the wall and the cover.

16. The system of claim 12, wherein the power cable assembly comprises a first portion and a second portion, the first portion routed across a first side of the motherboard and the second portion routed across a second side of the motherboard.

17. A method comprising:
disposing a motherboard in a chassis; and
routing a power cable assembly parallel to a plane of the motherboard, the power cable assembly comprising a plurality of power cables each in physical and electrical communication with a power supply, the power cable assembly organized in a 1×n array of power cables wherein n is a positive integer greater than five and the power cable assembly is in electrical communication with the motherboard.

18. The method of claim 17, wherein the power cable assembly is routed between the motherboard and an inner face of a wall of the chassis.

19. The method of claim 17, the chassis further comprising a wall and a cover, wherein the motherboard is disposed adjacent and parallel to an inner face of the wall and the power cable assembly is routed adjacent to an outer face of the wall and the cover is removably attached to the chassis covering the wall, wherein the power cable assembly is disposed between the outer face of the wall and the cover.

20. The system of claim 17, wherein the power cable assembly comprises a first portion and a second portion, the first portion routed across a first side of the motherboard and the second portion routed across a second side of the motherboard.
